(19) United States
(12) Patent Application Publication
(10) Pub. No.: US 2016/0081308 A1
(43) Pub. Date: Mar. 24, 2016

(54) Multiple Channel Spike for Dispensing Fluid From a Flexible Fluid Container, and Associated Method

(71) Applicant: Zoetis Services LLC, Florham Park, NJ (US)

(72) Inventors: Douglas Mark Cary, Chapel Hill, NC (US); Thomas Matthew Hessler, Raleigh, NC (US)

(21) Appl. No.: 14/859,423

(22) Filed: Sep. 21, 2015

Related U.S. Application Data
(60) Provisional application No. 62/053,350, filed on Sep. 22, 2014.

(51) Int. Cl. A01K 45/00

(52) U.S. Cl. CPC A01K 45/007

(57) ABSTRACT

A spike for dispensing fluid from a flexible fluid container is provided. Such a spike includes a puncturing tip and first and second internal channels. Each channel has a respective fluid inlet at the puncturing tip. The first and second internal channels terminate internally at a third internal channel in fluid communication with a fluid outlet. The puncturing tip has an apex offset from a longitudinal axis of the spike. Upon puncturing the flexible fluid container, fluid flows through the first and second internal channels, into the third internal channel, and out of the fluid outlet. An associated method is also provided.

### CROSS REFERENCE TO RELATED APPLICATION

This application claims the benefit of U.S. Provisional Patent Application No. 62/053,350, filed Sep. 22, 2014, which is expressly incorporated herein by reference in its entirety.

### TECHNICAL FIELD

The present disclosure generally relates to fluid dispensing devices. More particularly, the present disclosure relates to a multiple channel spike for puncturing a flexible fluid container so as to facilitate dispense of a fluid from the fluid container to a fluid dispensing system, and an associated method.

### BACKGROUND

In many instances, it is desirable to introduce a fluid substance into a live avian egg prior to hatch. Injection of various fluid substances into avian eggs is commonly referred to as in ovo injection. An egg injection apparatus (i.e., in ovo injection apparatus) may comprise a plurality of injection devices that operate simultaneously to inject a plurality of eggs. The egg injection apparatus typically includes a fluid delivery system for delivering fluid (e.g., vaccine) to the injection devices and into the eggs. A collapsible bag containing the fluid is connected to the fluid delivery system through appropriate tubing and connectors. A spike may be used to pierce or otherwise puncture the collapsible bag at a dedicated outlet port such that the fluid contained in the collapsible bag can be fed to the fluid delivery system. In the application of in ovo injection, the spike may also be used, once removed from collapsible bag, to connect a cleaning system to the fluid delivery system such that cleaning or sanitizing fluid can be delivered throughout the fluid delivery system and injection devices for cleaning and/or sanitizing the components thereof.

Unfortunately, previous spike configurations may allow for coring and/or tearing of the collapsible bag (typically a flexible plastic material), which allows fragments or debris of the collapsible bag to flow downstream to the fluid delivery system. In this regard, the fragments or debris of the collapsible bag may become lodged in various components of the fluid delivery system, such as, for example, a pump (e.g., duck bill valve), a fluid pathway, or the spike itself, such that one or more of the injection devices is unable to deliver fluid to the egg. Accordingly, it would be desirable to provide a non-coring/non-debris producing spike capable of providing an acceptable fluid flow rate for facilitating dispense of a fluid from a collapsible bag to the fluid delivery system of an in ovo injection apparatus. Furthermore, it would be desirable to provide an associated method that would facilitate delivery of a fluid from a collapsible bag to a fluid delivery system in a non-coring and non-debris producing manner and at an acceptable fluid flow rate.

### BRIEF SUMMARY

The above and other needs are met by aspects of the present disclosure which, according to one aspect, provides a spike for dispensing fluid from a flexible fluid container. The spike includes a shaft defining a longitudinal axis and having a proximal end and a distal end. A puncturing tip is disposed at the distal end. The puncturing tip has an apex offset from the longitudinal axis of the shaft. A first channel internal to the shaft includes a first fluid inlet on the puncturing tip through which fluid flows into the first channel. A second channel internal to the shaft includes a second fluid inlet on the puncturing tip through which fluid flows into the second channel. A fluid outlet is defined by the shaft at the proximal end. A third channel internal to the shaft and in fluid communication with the fluid outlet is provided. The third channel is formed at a section within the shaft where the first and second channels terminate.

Another aspect provides a method for dispensing fluid from a flexible fluid container. The method comprises providing a flexible fluid container having a liquid contained therein. The method further comprises the step of providing a spike comprising a puncturing tip and first and second internal channels. Each channel has a respective fluid inlet at the puncturing tip. The first and second internal channels terminate into a third internal channel in fluid communication with a fluid outlet. The puncturing tip has an apex offset from a longitudinal axis defined by the spike. The method further comprises the step of puncturing the flexible fluid container with the spike such that fluid from the flexible fluid container enters the spike at the respective fluid inlets of the first and second internal channels, whereby the fluid from the first and second internal channels flows into the third internal channel and out of the fluid outlet.

Thus, various aspects of the present disclosure provide advantages, as otherwise detailed herein.

### BRIEF DESCRIPTION OF THE DRAWINGS

Having thus described various embodiments of the present disclosure in general terms, reference will now be made to the accompanying drawings, which are not necessarily drawn to scale, and wherein:

FIGS. 1 and 2 are perspective views of a spike capable of puncturing a flexible fluid container for dispensing fluid therefrom, according to one aspect of the present disclosure;

FIG. 3 is a side view of the spike illustrated in FIGS. 1 and 2;

FIG. 4 is a cross-section of the spike illustrated in FIG. 3 along line 4-4;

FIG. 5 is a cross-section of the spike illustrated in FIG. 3 along line 5-5;

FIG. 6 is another side view of the spike illustrated in FIGS. 1 and 2;

FIG. 7 is a cross-section of the spike illustrated in FIG. 6 along line 7-7;

FIG. 8 is an end view of the spike illustrated in FIGS. 1 and 2;

FIGS. 9-12 are perspective sectional views of a spike having a puncturing tip with a plurality of fluid inlets, according to one aspect of the present disclosure.

### DETAILED DESCRIPTION OF THE DISCLOSURE

Various aspects of the present disclosure now will be described more fully hereinafter with reference to the accompanying drawings, in which some, but not all aspects of the disclosure are shown. Indeed, this disclosure may be embodied in many different forms and should not be construed as limited to the aspects set forth herein; rather, these aspects are provided so that this disclosure will satisfy applicable legal requirements. Like numbers refer to like elements throughout.

In facilitating delivery of a liquid fluid to a fluid delivery system of an in ovo injection apparatus, the present disclosure provides a spike 100 capable of piercing, penetrating, or otherwise puncturing a portion of a flexible fluid container, such as a collapsible bag, containing the fluid. The spike 100 may also be attached to flexible tubing in fluid communication with the fluid delivery system such that once the fluid container is pierced the fluid is drawn via pumps from the fluid container through the spike and then onto the fluid delivery system. In this regard, the overall size of the spike 100 may be generally constrained by the dimensions of the tubing and a connector or port of the fluid container. According to the present disclosure, the spike 100 may be configured to reduce coring or tearing of the fluid container, while also providing acceptable strength and suitable fluid flow rates therethrough using multiple channels or lumens so as to allow the fluid delivery system to function appropriately. As used herein, the term “coring” refers to the act of separating a piece or fragment from the whole, such as coring an apple wherein the core is separated from the remainder of the apple.

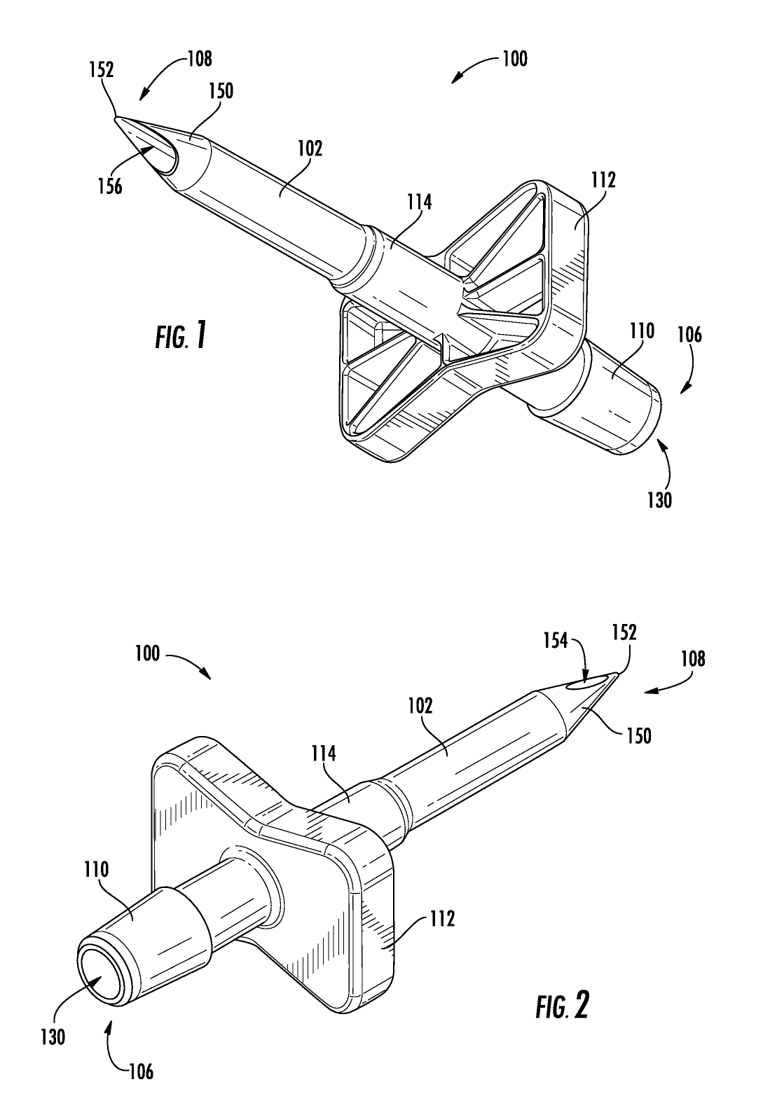

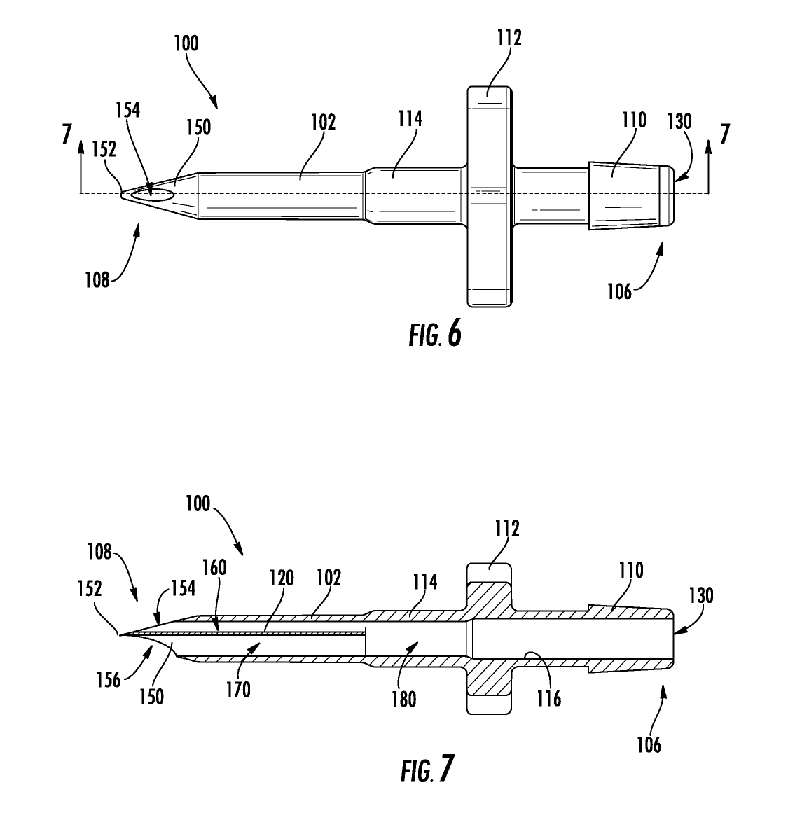

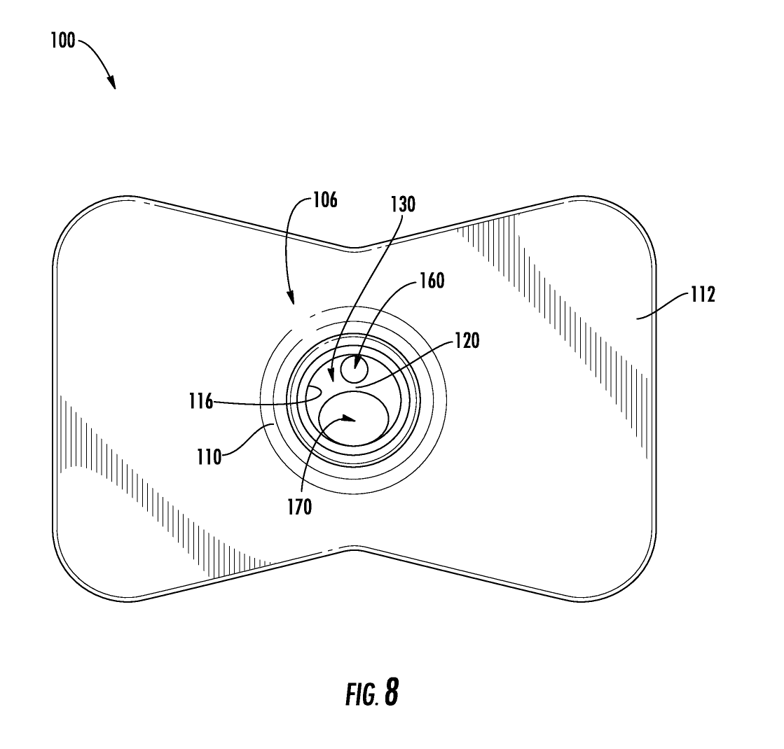

According to some aspects, as shown in FIGS. 1-4, 6 and 7, the spike 100 may include an elongate shaft 102 defining a longitudinal (central) axis 104 (FIG. 12). The spike 100 may have a proximal end 106 and a distal end 108. A retention barb 110 may be disposed at the proximal end 106 to facilitate attachment to flexible fluid tubing that connects to the fluid delivery system. A handle 112 may be disposed along the shaft 102 and extend perpendicular to the longitudinal axis 104. A shaft collar 114 may be provided along the shaft 102 for providing an interference fit with a portion of the fluid container or an interfacing tube structure, such as a port connector, such that the spike 100 remains securedly attached to the fluid container.

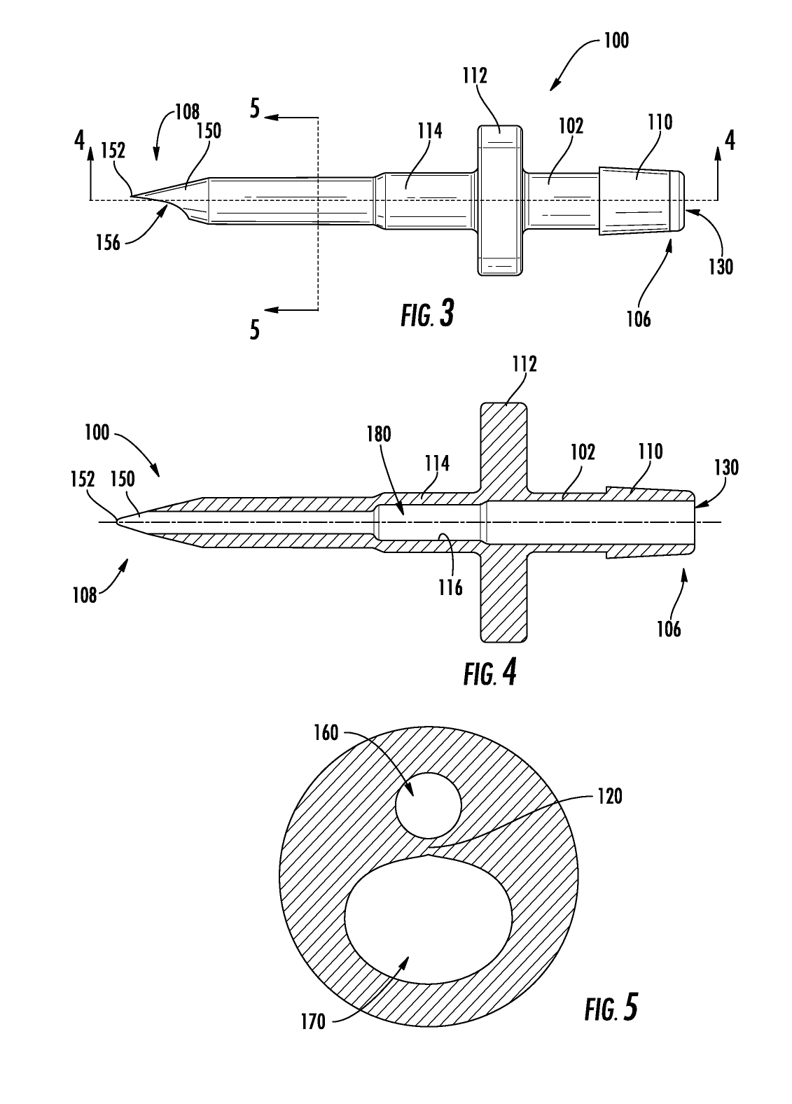

A puncturing tip 150 may be provided at the distal end 108 of the spike 100. The puncturing tip 150 may have an apex 152 or tip point offset from the longitudinal axis 104, as shown in FIGS. 3 and 12, such that the fluid container is pierced off center. For example, the fluid container may include a tube-shaped port connector having a circular port seal (perpendicularly arranged within and with respect to the tube-shaped port connector) that must be pierced or penetrated to allow fluid to drain from the fluid container. In this regard, the apex 152 of the puncturing tip 150 may initially pierce or puncture the port seal such that the shaft 102 may be advanced within the tube-shaped port connector to the point that the shaft collar 114 is received within the port connector and further advancement of the spike 100 is impeded by the handle 112. Offsetting the apex 152 provides protection to the port seal so as to prevent coring or separation thereof. In some instances, the apex 152 may be sharp, while in other instances the apex 152 may be generally dull.

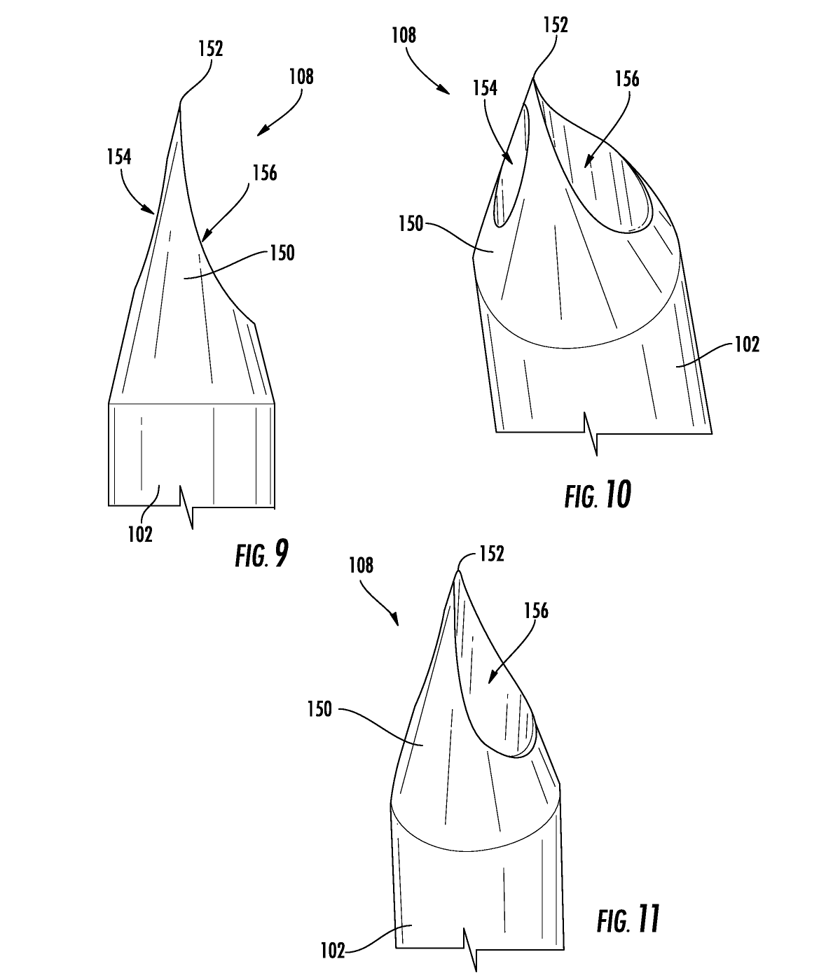

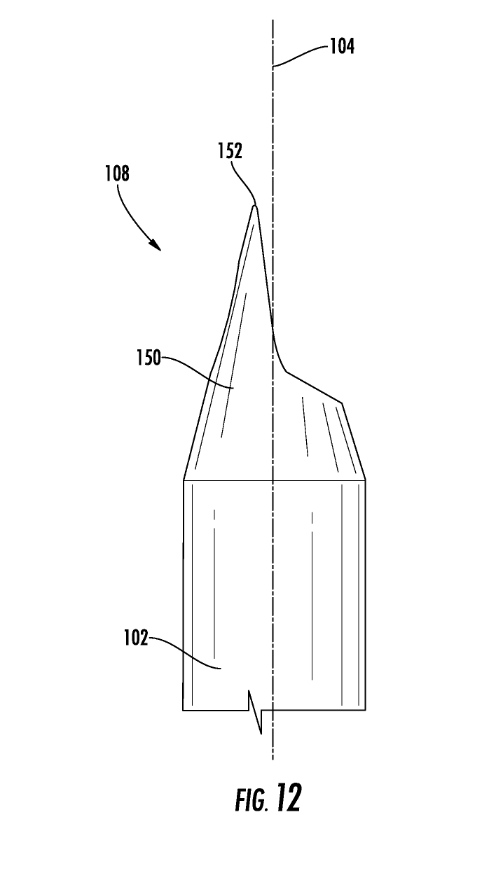

According to some aspects, the puncturing tip 150 may be formed at the distal end 108 where the shaft 102 transitions from a cylindrical configuration to a conical configuration, such that the puncturing tip 150 is formed initially at the transition and extends to the apex 152. In this regard, the puncturing tip 150 may begin where the shaft 102 tapers proximate to the distal end 108. As shown in FIG. 10, the puncturing tip 150 may include a first fluid inlet 154 and a second fluid inlet 156, which allow fluid from the fluid container to enter the spike 100. The first and second fluid inlets 154, 156 may be disposed on opposite sides of the puncturing tip 150, in some instances. The profile of the second fluid inlet 156 contributes to the configuration of the portion of the puncturing tip 150 that causes the initial piercing of the fluid container. In this regard, the profile of the second fluid inlet 156 may be defined as a compound curve with a transition from a sharp edge to a radius edge, which reduces the potential for coring, tearing, or separating of the fluid container, as shown in FIGS. 9-11.

The first fluid inlet 154 may act as an entrance for fluid from the fluid container to enter a first channel 160 internal to the shaft 102, thereby forming a first fluid path. The second fluid inlet 156 may act as an entrance for fluid from the fluid container to enter a second channel 170 internal to the shaft 102, thereby forming a second fluid path. The first channel 160 and the second channel 170 may be separated by a septum 120 acting as a dividing structure therebetween, as shown in FIGS. 5, 7 and 8. In some instances, the septum 120 may be molded internally within the shaft 102. According to some aspects, the septum 120 may form a portion of the puncturing tip 150, wherein the septum 120 extends from the puncturing tip 150 into the shaft 102.

The septum 120 may terminate within the shaft 102 prior to the proximal end 106. At the point where the septum 120 terminates within the shaft 102, the first channel 160 and the second channel 170 may also terminate so as to form an entrance for fluid flowing respectively therethrough to enter a third channel 180 internal to the shaft 102, thereby forming a third fluid path. In this regard, fluid from the first channel 160 and the second channel 170 may flow cooperatively into the third channel 180, which may be defined by an inner wall 116 of the spike 100 or shaft 102. The third channel 180 may be in fluid communication with a fluid outlet 130 disposed at the proximal end 106 and defined by the shaft 102 or the retention barb 110, wherein fluid exits the spike 100 via the fluid outlet 130. The use of two inlets (first fluid inlet 154 and second fluid inlet 156) and two channels (first channel 160 and second channel 170) to transfer fluid to a common channel (third channel 180) and out of the spike 100 may provide maximum flow of the fluid so as to achieve acceptable fluid flow rates through the spike 100. In this regard, the spike 100 may be capable of achieving a fluid flow rate of about 19 mL/sec, using deionized (DI) water as the fluid.

According to some aspects of the present disclosure, the handle 112 may be indexed relative to the offset puncturing tip 150 so as to act as an anti-sidewall tube piercing feature. By indexing the handle 112 relative to the offset puncturing tip 150, the apex 152 is positioned in the left to right visible field of the operator. The natural alignment feature provides a non-projected view of the puncturing tip 150 on insertion, thus giving the operator optimal conditions for insertion of the spike 100 without contacting the sidewalls of the tube-shaped port connector.

The spike 100 may be constructed of various materials, including metals, polymers, ceramics, or other suitable materials. In some instances, the material selection for the spike 100 may be based upon the chemical resistance thereof since the spike 100 may also be used as the fluid transfer connector for connecting the cleaning system with the fluid delivery system and injection devices of an in ovo injection apparatus. In such instances, the spike 100 may be subjected daily to cleaning and/or sanitizing chemicals. As such, in some instances, the spike 100 may be constructed from various polymer materials such as, for example, nylon-ABS, glass filled polypropoylene (PPGF), glass filled polycarbonate, polycarbonate-polyester, acetyl, or polycarbonate-ABS.

Many modifications and other aspects of the present disclosure set forth herein will come to mind to one skilled in the art to which this disclosure pertains having the benefit of the teachings presented in the foregoing descriptions and the associated drawings. Therefore, it is to be understood that the present disclosure is not to be limited to the specific aspects disclosed and that modifications and other aspects are intended to be included within the scope of the appended claims. Although specific terms are employed herein, they are used in a generic and descriptive sense only and not for purposes of limitation.

That which is claimed:

1. A spike for dispensing fluid from a flexible fluid container, the spike comprising:
a shaft defining a longitudinal axis, the shaft having a proximal end and a distal end;
a puncturing tip disposed at the distal end, the puncturing tip having an apex offset from the longitudinal axis of the shaft;
a first channel internal to the shaft, the first channel having a first fluid inlet on the puncturing tip through which fluid flows into the first channel;
a second channel internal to the shaft, the second channel having a second fluid inlet on the puncturing tip through which fluid flows into the second channel;
a fluid outlet defined by the shaft at the proximal end; and
a third channel internal to the shaft and in fluid communication with the fluid outlet, the third channel being formed at a section within the shaft where the first and second channels terminate.

2. A spike according to claim 1, further comprising a septum internal to the shaft for separating the first and second channels.

3. A spike according to claim 1, wherein the first and second channels differ in at least one of size and shape.

4. A spike according to claim 1, wherein the first channel is defined as a cylindrical volume and the second channel is defined as an elliptic cylindrical volume.

5. A spike according to claim 1, further comprising a retention barb disposed at the proximal end and defining the fluid outlet, the retention barb being configured to receive and retain fluid tubing thereon.

6. A spike according to claim 1, further comprising a retention collar external to the shaft, the retention collar being configured to be received within fluid tubing.

7. A method for dispensing fluid from a flexible fluid container, the method comprising:
providing a flexible fluid container having a fluid contained therein;
providing a spike comprising a puncturing tip and first and second internal channels, each channel having a respective fluid inlet at the puncturing tip, the first and second internal channels terminate into a third internal channel in fluid communication with a fluid outlet, the puncturing tip having an apex offset from a longitudinal axis defined by the spike; and
puncturing the flexible fluid container with the spike such that fluid from the flexible fluid container enters the spike at the respective fluid inlets of the first and second internal channels, the fluid from the first and second internal channels flowing into the third internal channel and out of the fluid outlet.

8. A method according to claim 7, wherein providing a spike further comprises providing a spike having an internal septum to separate the first and second channels.

9. A method according to claim 7, wherein fluid enters the respective fluid inlets of the first and second internal channels, the first channel being cylindrical and the second channel being elliptically cylindrical.

10. A method according to claim 7, wherein the first and second channels are defined to have different sizes and shapes with respect to each other.
